(19) United States
(12) Patent Application Publication
(10) Pub. No.: US 2012/0053954 A1
(43) Pub. Date: Mar. 1, 2012

(54) QUALITY METRIC MONITORING

(75) Inventors: Catherine Whelchel, Spartanburg, SC (US); Andrew Mellin, St. Paul, MN (US); John Faughnan, St. Paul, MN (US); Michael Altmann, Minneapolis, MN (US)

(73) Assignee: McKesson Financial Holdings Limited

(21) Appl. No.: 12/868,076

(22) Filed: Aug. 25, 2010

(51) Int. Cl. G06Q 50/00; G06Q 90/00

(52) U.S. Cl. 705/2; 705/500

(57) ABSTRACT

Systems, methods, apparatus, and computer program products are provided for monitoring quality metrics for patients in health care facilities. For example, in one embodiment, a monitoring server can monitor a set of quality metrics associated with a patient in a health care facility. During the monitoring process, the monitoring server can determine whether activities associated with the respective quality metrics have been or need to be performed, providing medical providers information in time to correct care documentation. The monitoring server can also cause display of graphics that indicate the results of such determinations.

### BACKGROUND

Today, reporting and quality review associated with the quality of care a patient receives in a health care facility is often accomplished after the patient is discharged. Thus, there is no mechanism for monitoring trends in patient care while patients are being treated at a health care facility. For example, a medical provider (e.g., nurse) may repeat the same error or fail to document a prescribed treatment multiple times before the issue is brought to the attention of the appropriate supervisors. Thus, a need exists to provide a mechanism for monitoring and evaluating patient care while patients are being treated at health care facilities, and such that a user has the opportunity to correct documentation when a task has been performed and not documented while the patient is still hospitalized.

### BRIEF SUMMARY

In general, embodiments of the present invention provide systems, methods, apparatus, and computer program products for monitoring quality metrics for patients in health care facilities.

In accordance with one aspect, a method for monitoring quality metrics is provided. In one embodiment, the method may include (1) receiving input initiating the monitoring of a quality metric associated with a patient in a health care facility, wherein the quality metric is associated with one or more activities that are to be performed corresponding to the patient; (2) identifying clinical patient data corresponding to the quality metric; and (3) determining, based at least in part on the clinical patient data, whether an activity associated with the quality metric has been performed within (a) a first predetermined time period and (b) a second predetermined time period. In one embodiment, the method may also include (4) after determining whether the activity associated with the quality metric has been performed within the first predetermined time period and the second predetermined time period, updating a status of the quality metric to indicate whether the activity associated with the quality metric has been performed within the first predetermined time period and the second predetermined time period; and (5) after updating the status of the quality metric, causing display of a first graphic for the quality metric indicating the status of the first predetermined time period and the second predetermined time period.

In accordance with yet another aspect, a computer program product for monitoring quality metrics is provided. The computer program product may comprise at least one computer-readable storage medium having computer-readable program code portions stored therein, the computer-readable program code portions comprising executable portions configured to (1) receive input initiating the monitoring of a quality metric associated with a patient in a health care facility, wherein the quality metric is associated with one or more activities that are to be performed corresponding to the patient; (2) identify clinical patient data corresponding to the quality metric; and (3) determine, based at least in part on the clinical patient data, whether an activity associated with the quality metric has been performed within (a) a first predetermined time period and (b) a second predetermined time period. In one embodiment, the computer-readable program code portions may also comprise executable portions configured to (4) after determining whether the activity associated with the quality metric has been performed within the first predetermined time period and the second predetermined time period, update a status of the quality metric to indicate whether the activity associated with the quality metric has been performed within the first predetermined time period and the second predetermined time period; and (5) after updating the status of the quality metric, cause display of a first graphic for the quality metric indicating the status of the first predetermined time period and the second predetermined time period.

In accordance with yet another aspect, an apparatus comprising at least one processor and at least one memory including computer program code is provided. In one embodiment, the at least one memory and the computer program code may be configured to, with the processor, cause the apparatus to at least (1) receive input initiating the monitoring of a quality metric associated with a patient in a health care facility, wherein the quality metric is associated with one or more activities that are to be performed corresponding to the patient; (2) identify clinical patient data corresponding to the quality metric; and (3) determine, based at least in part on the clinical patient data, whether an activity associated with the quality metric has been performed within (a) a first predetermined time period and (b) a second predetermined time period. In one embodiment, the at least one memory and the computer program code may also be configured to, with the processor, cause the apparatus to at least (4) after determining whether the activity associated with the quality metric has been performed within the first predetermined time period and the second predetermined time period, update a status of the quality metric to indicate whether the activity associated with the quality metric has been performed within the first predetermined time period and the second predetermined time period; and (5) after updating the status of the quality metric, cause display of a first graphic for the quality metric indicating the status of the first predetermined time period and the second predetermined time period.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice various embodiments of the present invention.

FIG. 2 is an illustrative schematic diagram of a monitoring server according to one embodiment of the present invention.

FIGS. 3A, 3B, 3C, 3D, 3E, 3F, 3G, 3H, 3I, 3J, and 3K are illustrative graphics that can be used with one embodiment of the present invention.

FIGS. 4-9 show illustrative input/output that can be produced according to one embodiment of the present invention.

FIG. 10 is a flowchart illustrating operations and processes that can be used in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout. The term “illustrative” is used to be an example with no indication of quality level.

### I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. Illustrative System Architecture

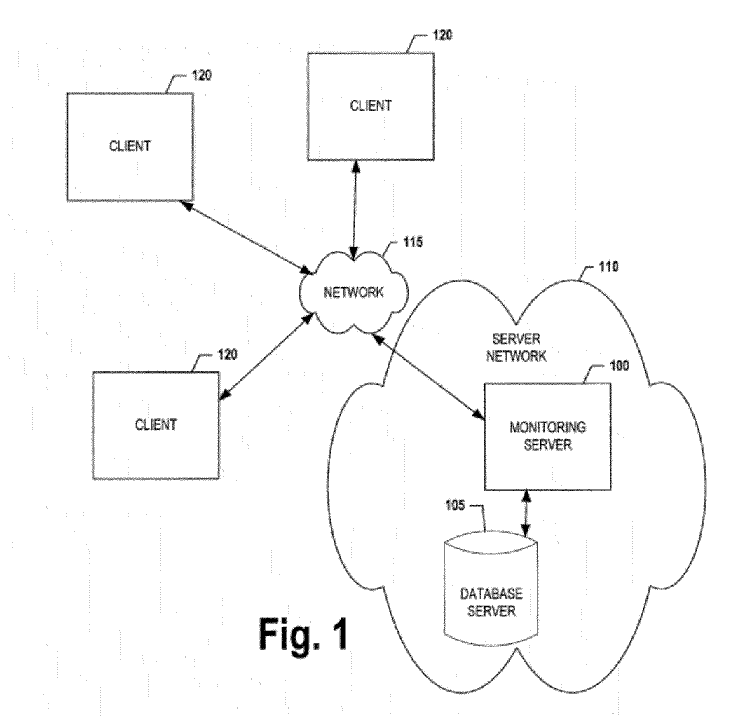

FIG. 1 provides an illustration of a system that can be used in conjunction with various embodiments of the present invention. As shown in FIG. 1, the system may include one or more monitoring servers 100, one or more database servers 105, one or more server networks 110, one or more networks 115, and one or more clients 120. Each of the components of the system may be in electronic communication with, for example, one another over the same or different wireless or wired networks including, for example, a wired or wireless Personal Area Network (“PAN”), Local Area Network (“LAN”), Metropolitan Area Network (“MAN”), Wide Area Network (“WAN”), or the like. Additionally, while FIG. 1 illustrates certain system entities as separate, standalone entities, the various embodiments are not limited to this particular architecture.

### 1. Illustrative Monitoring Server

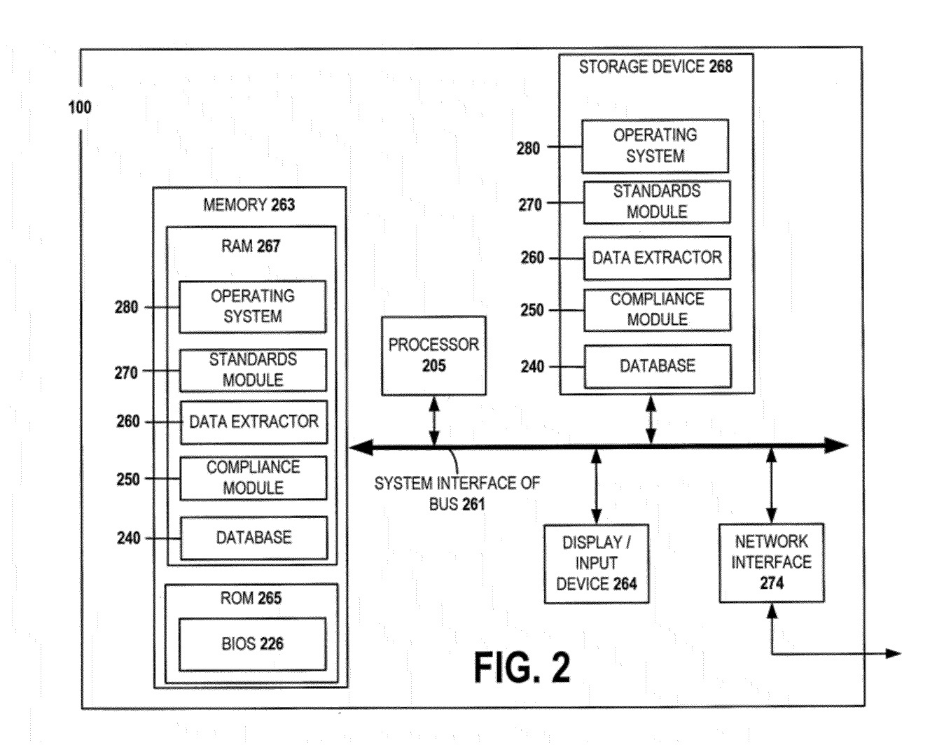

FIG. 2 provides a schematic of a monitoring server 100 according to one embodiment of the present invention. In general, the term “server” may refer to, for example, any computer, computing device, mobile phone, desktop, notebook or laptop, distributed system, server, blade, gateway, switch, processing device, or combination of processing devices adapted to perform the functions described herein. As will be understood from this figure, in one embodiment, the monitoring server 100 includes a processor 205 that communicates with other elements within the monitoring server 100 via a system interface or bus 261. The processor 205 may be embodied in a number of different ways. For example, the processor 205 may be embodied as a processing element, a coprocessor, a controller or various other processing devices including integrated circuits such as, for example, an application specific integrated circuit (“ASIC”), a field programmable gate array (“FPGA”), a hardware accelerator, or the like.

In an illustrative embodiment, the processor 205 may be configured to execute instructions stored in the device memory or otherwise accessible to the processor 205. As such, whether configured by hardware or software methods, or by a combination thereof, the processor 205 may represent an entity capable of performing operations according to embodiments of the present invention when configured accordingly. A display device/input device 264 for receiving and displaying data may also be included in the monitoring server 100. This display device/input device 264 may be, for example, a keyboard or pointing device that is used in combination with a monitor. The monitoring server 100 may further include tangible and non-transitory memory 263, which may include both read only memory (“ROM”) 265 and random access memory (“RAM”) 267. The monitoring server's ROM 265 may be used to store a basic input/output system (“BIOS”) 226 containing the basic routines that help to transfer information to the different elements within the monitoring server 100.

In addition, in one embodiment, the monitoring server 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (“MMCs”), secure digital (“SD”) memory cards, Memory Sticks, electrically erasable programmable read-only memory (“EEPROM”), flash memory, hard disk, or the like. Additionally, each of these storage devices 268 may be connected to the system bus 261 by an appropriate interface.

Furthermore, a number of program modules may be stored by the various storage devices 268 and/or within RAM 267. Such program modules may include an operating system 280, a standards module 270, a data extractor module 260, and a compliance module 250. As discussed in more detail below, these modules may control certain aspects of the operation of the monitoring server 100 with the assistance of the processor 205 and operating system 280—although their functionality need not be modularized. In addition to the program modules, the monitoring server 100 may store or be in communication with one or more databases (e.g., database 240) or one or more database servers 105.

Also located within the monitoring server 100, in one embodiment, is a network interface 274 for interfacing with various computing entities. This communication may be via the same or different wired or wireless networks (or a combination of wired and wireless networks), as discussed above. For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the monitoring server 100 may be configured to communicate via wireless external communication networks using any of a variety of protocols, such as 802.11, general packet radio service (“GPRS”), wideband code division multiple access (“W-CDMA”), Long Term Evolution (“LTE”), IEEE 802.11 (“Wi-Fi”), 802.16 (“WiMAX”), ultra wideband (“UWB”), and/or any other wireless protocol.

It will be appreciated that one or more of the monitoring server's 100 components may be located remotely from other monitoring server 100 components. Furthermore, one or more of the components may be combined and additional components performing functions described herein may be included in the monitoring server 100.

In one embodiment, the monitoring server 100 may be configured to provision a patient quality monitor to clients 120. In this regard, for example, the monitoring server 100 may include a dashboard service application comprising stored instructions for accessing information (e.g., via communication with the database server 105) and providing such information to the client applications based on requests provided at each respective client 120.

### 2. Illustrative Database Server

In one embodiment, as shown in FIG. 1, the monitoring server 100 may be in electronic communication with the database server 105. The database server 105 may be configured to receive, store, and provide access to clinical patient data (e.g., patient information, treatment information, test results, medical history, orders, medications, and/or numerous other types of information). For example, the database server 105 may accept core clinical data updates of observations, medication administrations, intravenous (IV) administrations, orders and other similar data that may be provided in the context of an electronic medical record or other health care system electronic data gathering and/or storage regimes. To do so, the database server 105 may include (1) processing elements, (2) memory, (3) network interfaces, (4) transceivers, and/or (5) various other components.

### 3. Illustrative Clients

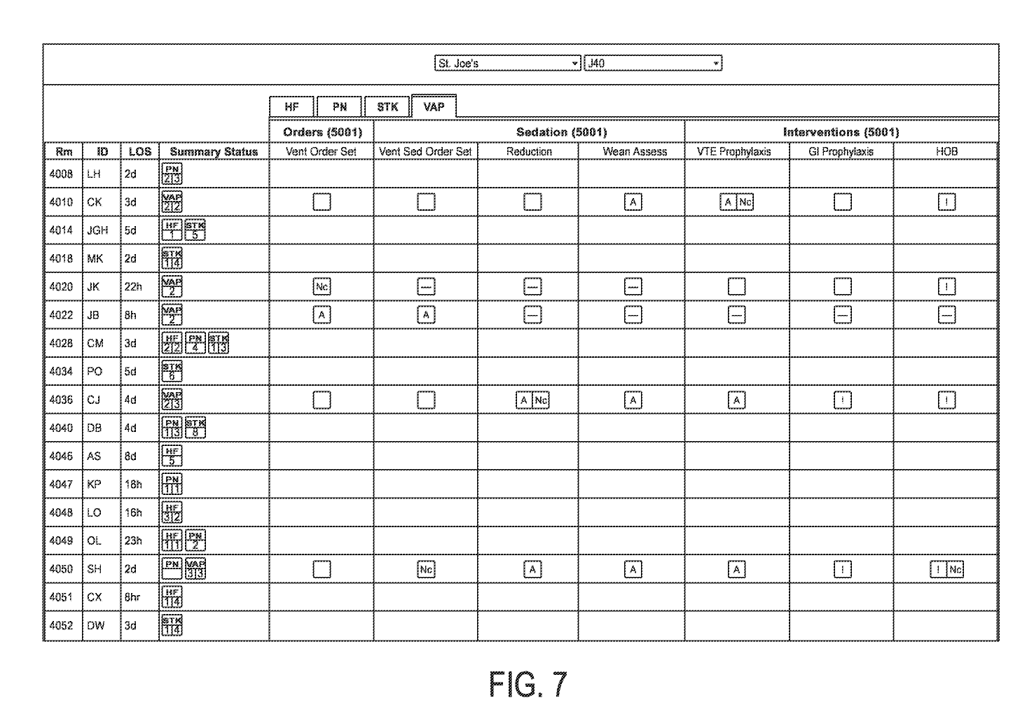

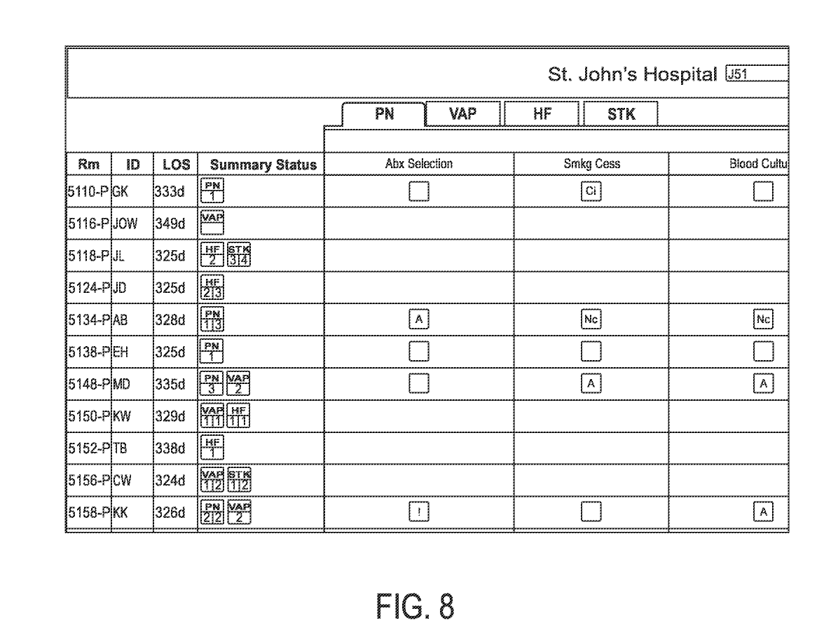

As shown in FIG. 1, a system according to an illustrative embodiment may include one or more clients 120. In one embodiment, clients 120 may include components such as (1) processing elements, (2) memory, (3) network interfaces, (4) transceivers, and/or (5) various other components. Via such components, the clients 120 may display/present information, for example, related to patients in a health care facility. For instance, in one embodiment, the one or more clients 120 may be associated with different corresponding units, wings, and/or departments of a health care facility. Thus, one client 120 may be associated with a first hospital unit (e.g., an intensive care unit (“ICU”)), and a second client 120 may be associated with a second hospital unit (e.g., a respiratory therapy unit). However, information associated with multiple units may alternatively be accessible via a single client 120. Furthermore, in some cases, multiple clients 120 may be associated with the same unit. For example, clients 120 could be located at nurse's stations, at various locations in hallways within a treatment unit or even within patient rooms. Irrespective of the configuration, the one or more clients 120 can present/display information related to patients in a health care facility, such as via a dashboard display (see FIGS. 7-9).

### III. Illustrative System Operation

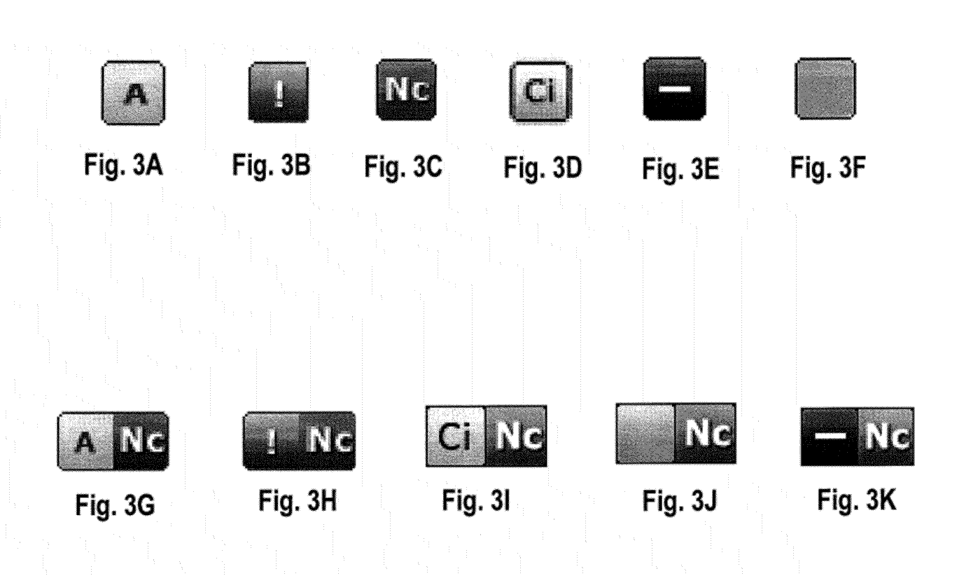

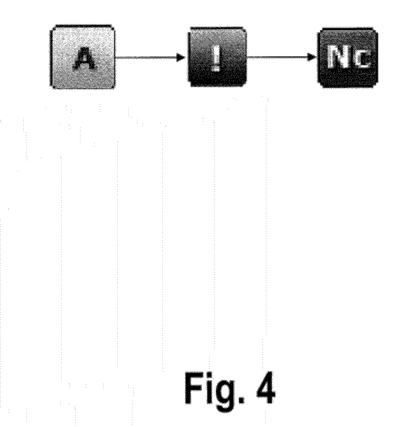

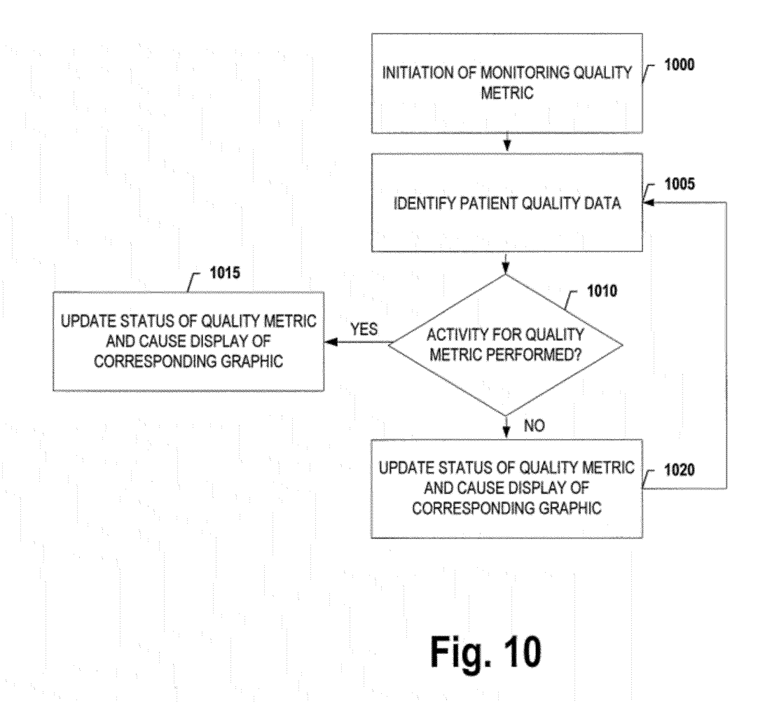

Reference will now be made to FIGS. 3-10. FIGS. 3A, 3B, 3C, 3D, 3E, 3F, 3G, 3H 3I, 3J, and 3K are illustrative graphics that can be used to provide the status of specific quality metrics or sets of quality metrics. FIGS. 4-9 show illustrative input/output that can be displayed/presented associated with quality metrics or sets of quality metrics. FIG. 10 is a flowchart illustrating operations and processes that can be used to display/present information associated with quality metrics or sets of quality metrics.

### 1. Quality Metrics

For many illnesses, conditions, and/or treatments, for example, there may be certain quality metrics (or sets of quality metrics) that can be performed to improve the care of a patient. For instance, quality metrics may include activities that, if performed/completed at a prescribed time or interval, may reduce the likelihood of encountering complications or other negative outcomes. Such quality metrics (e.g., activities) may be one-time activities and/or reoccurring activities (e.g., performed at periodic or regular intervals). In one embodiment, quality metrics (e.g., activities) may be standards defined by an organization external to a health care provider, such as the Institute for Healthcare Improvement (“IHI”), Centers for Disease Control (“CDC”), Joint Commission on the Accreditation of Healthcare Organizations (“JCAHO”), Agency for Healthcare Research and Quality (“AHRQ”), and/or other similar agencies or bodies. Although quality metrics may be nationally prescribed, in one embodiment, the quality metrics may be further customized by health care providers.

In one embodiment, a set of quality metrics may be associated with a particular treatment, diagnosis, and/or health condition, such as, for example, ventilator associated pneumonia (“VAP”). VAP is a condition that can either be fatal or greatly increase health care costs and patient stays for patients who are placed on a ventilator. Various quality metrics (e.g., activities) have been defined for medical providers to perform/complete in combination to reduce the risk of VAP. Such quality metrics (e.g., activities) for VAP may include (a) elevating the head of a patient's bed 30 to 45 degrees at least once every 12 hours and (b) regularly providing oral cleansing. Additional quality metrics for VAP may include (c) wean assessments (e.g., determining whether a patient can be weaned from the ventilator) and/or (d) sedation reduction (e.g., reducing the sedation of the patient to bring him/her up from an induced coma).

As will be recognized, the number and types of quality metrics and sets of quality metrics may vary to adapt to a variety of needs and circumstances. For example, a variety of diseases, conditions, treatments, and/or diagnoses may have respective quality metrics associated therewith. For instance, as shown in FIGS. 7-9, there may be sets of quality metrics associated with a variety of treatments, diagnoses, and/or health conditions, such as (a) a set of quality metrics for heart failure (“HF”) patients, (b) a set of quality metrics for stroke (“STK”) patients, and/or (c) a set of quality metrics for pneumonia (“PN”) patients.

In one embodiment, each quality metric may be associated with one or more predetermined time periods for performing/completing the quality metric (e.g., activity). The predetermined time periods for performing/completing the quality metrics may vary. For instance, a predetermined time period for performing/completing a quality metric may be minutes, hours, days, or the entire stay of a particular patient. Such information may be stored, for example, in the database server 105 via the monitoring server 100 and further customized by health care providers.

In one embodiment, the monitoring server 100 can monitor quality metrics for patients and provide an “at a glance” real-time view regarding their respective statuses (see FIGS. 7-9). In certain embodiments, this may provide medical providers, for example, with the ability to (a) identify trends of noncompliance with quality metrics, (b) prevent noncompliance with quality metrics before they occur, and/or (c) identify opportunities to correct documentation when a quality metric has been performed but not documented while the patient is still in the health care facility.

### 2. Initiating the Monitoring of Quality Metrics

In various embodiments, as indicated in Block 1000 of FIG. 10, the monitoring of a quality metric or set of quality metrics associated with a patient in a health care facility may be initiated using a variety of techniques. In one embodiment, the monitoring of a set of quality metrics may be initiated by the charting (or recording) of an event or the performance of an activity. For example, the set of quality metrics for VAP can be initiated when an intubation event is charted by a respiratory therapist through manual input, for example, using drop-down menus via a client 120. Similarly, the set of quality metrics for VAP may be initiated via a barcode scan of the ventilator and a patient's identification bracelet indicating that the patient is on a ventilator. The set of quality metrics for VAP may also be initiated by, for example, a medical provider's order set (instructing that the patient be intubated) being input via a client 120.

Additionally or alternatively, charting the performance of an x-ray and/or a patient as being admitted into a particular unit (e.g., intensive care unit) in a health care facility may initiate the monitoring of a set of quality metrics. Similarly, the charting or generation of specific lab results or charting of the administration of certain medications may initiate the monitoring of a set of quality metrics. As will be recognized, a variety of approaches and techniques may be used to initiate the monitoring of a set of quality metrics for a patient. Accordingly, the foregoing examples are provided for illustrative purposes only and should not be taken in any way as limiting embodiments of the present invention to the examples provided. In one embodiment, once the monitoring has been initiated, the monitoring server 100 can monitor the quality metric and/or set of quality metrics.

### 3. Monitoring and Display of Quality Metrics

In one embodiment, as indicated in Block 1005 of FIG. 10, the monitoring server 100 (e.g., via the data extractor module 260) may be configured to identify/extract clinical patient data regarding activities logged, charted, input, scanned, and/or otherwise recorded that correspond to quality metrics or sets of quality metrics. Thus, for example, clinical patient data (e.g., results of observations or orders that have been conducted and recorded electronically in the database server 105) may be extracted on a routine, periodic, and/or continuous basis to provide updated status information with respect to each quality metric. For instance, the monitoring server 100 (e.g., via the data extractor module 260) may be configured to update the status of each quality metric every five minutes or at some other regular interval. However, in some cases, the monitoring server 100 (e.g., via the compliance module 250) may be configured to update the status of a selected quality metric (or set of quality metrics) in response to receiving input from a user.

In one embodiment, as indicated in Block 1010 of FIG. 10, after the monitoring server 100 identifies (e.g., via the data extractor module 260) clinical patient data corresponding to a quality metric, the monitoring server 100 (e.g., via the standards module 270) may determine whether an activity associated with the quality metric has been performed/completed within one or more predetermined time periods. This determination may be made based at least in part on the clinical patient data. The one or more time periods may, for example, correspond to a current time period and one or more past time periods, including the most-recent past time period. Thus, for instance, if the activity associated with the quality metric has been charted as being performed/completed within the one or more predetermined time periods (e.g., the current time period and/or most-recent past time period (if applicable)), the monitoring server 100 (e.g., via the compliance module 250) can update the status of the quality metric and cause display of a corresponding graphic (Block 1015 of FIG. 10). Similarly, if the activity associated with the quality metric has not been charted as being performed/completed within the one or more predetermined time periods (e.g., the current time period and/or most-recent past time period (if applicable)), the monitoring server 100 (e.g., via the compliance module 250) can update the status of the quality metric and cause display of a corresponding graphic (Block 1020 of FIG. 10). As with the extraction of clinical patient data, the monitoring server 100 (e.g., via the compliance module 250) may be configured to make such determinations and update the statuses of reoccurring and one-time quality metrics on a routine, periodic, and/or continuous basis.

In addition to updating the status of quality metrics on a routine, periodic, and/or continuous basis, the monitoring server 100 may update the status of quality metrics in response to the charting of an event or the recordation of the performance/completion of a quality metric (e.g., activity). For example, a quality metric for VAP may be updated via (a) a barcode scan of a patient's bracelet and a barcode scan of medicine being administered, (b) manual input, for example, using drop-down menus via a client 120, (c) charting the performance of an x-ray, and/or (d) charting or the generation of specific lab results. In various embodiments, charting or recording the performance/completion of a quality metric (e.g., activity) may occur (a) before a predetermined time period for the quality metric begins, (b) during a predetermined time period for the quality metric, and/or (c) after a predetermined time period for the quality metric ends. In one embodiment, by allowing the recordation/charting of the performance/completion of a quality metric (e.g., activity) to occur after a predetermined time period for the quality metric ends, the monitoring server 100 can provide opportunities to correct documentation (e.g., back-chart) when a quality metric has been performed but not documented while a patient is still in a health care facility. In various embodiments, this may provide for more accurate reporting that better reflects the actual care provided. As will be recognized, a variety of approaches and techniques may be used to update the status of quality metrics.

In one embodiment, graphics associated with the status of various quality metrics and/or sets of quality metrics can be displayed/presented using a variety of techniques and approaches. For example, in one embodiment, the monitoring server 100 can cause display of the graphics using dashboard displays (e.g., being displayed by clients 120). As shown in these figures, the dashboard may be organized by health care unit, rooms, halls, patient conditions, lengths of stays, sets of quality metrics, and individual quality metrics. Thus, for instance, each of the patients and her applicable sets of quality metrics and corresponding statuses may be shown via a dashboard display (e.g., being displayed by clients 120). In providing the graphics, the monitoring server 100 may be configured to provide a user with the ability to customize the display and/or the dashboard. For instance, a user may customize the color scheme or coding scheme for indicating different status conditions. Similarly, a user may customize the presentation of certain sets of quality metrics and/or quality metrics within the respective sets. Some users may desire to have the quality metric combined into a single status graphic, while other users may desire to have each of the multiple activities separately reported with their own respective status graphics.

As indicated, in one embodiment, the monitoring server 100 and/or clients 120 can cause display/presentation of graphics that provide the status of specific quality metrics or sets of quality metrics. For example, FIGS. 3A, 3B, 3C, 3D, 3E, 3F, 3G, 3H, 3I, 3J, and 3K are illustrative graphics that can be used to provide the status of specific quality metrics or sets of quality metrics. In one embodiment, the graphic in FIG. 3A is an illustrative actionable graphic that may be used to indicate that a quality metric is actionable for the current time period (e.g., that a particular activity for the quality metric is applicable to a patient and/or ready for completion). An actionable graphic may be provided for a corresponding quality metric from, for example, the time of applicability until a predetermined time period before the current time period is set to expire (e.g., 1 hour) or until the quality metric becomes compliant. In one embodiment, for a reoccurring quality metric, the actionable graphic may also indicate that the quality metric is compliant, for example, for the most-recent past time period.

The graphic in FIG. 3B is an illustrative urgent graphic that may be used to indicate a quality metric is urgent for the current time period (e.g., that a particular activity for the quality metric requires urgent attention for completion prior to the rapidly approaching expiration of the time period for completion). An urgent graphic may be provided from a predetermined time period before the current time period is set to expire (e.g., 1 hour), until the quality metric becomes compliant, or until the quality metric becomes noncompliant. In one embodiment, for a reoccurring quality metric, the urgent graphic may also indicate that the quality metric is compliant, for example, for the most-recent past time period.

The graphic in FIG. 3C is an illustrative noncompliant graphic that may be used to indicate a quality metric is noncompliant for the current time period or a past time period (e.g., that a time period for a particular activity for the quality metric has expired without charting the corresponding activity as being completed).

FIG. 3D shows an illustrative contraindicated graphic. The contraindicated graphic may be used to indicate that a particular quality metric may, for example, have an adverse consequence on the patient and is therefore not prescribed. For instance, a patient's blood may be too thin for a medication that thins the blood. In another example, the patient may have an allergy to a particular medication that is typically used to treat a health condition.

FIG. 3E shows an illustrative non-applicable graphic that may be used to indicate that a particular quality metric is not applicable to a patient.

The graphic in FIG. 3F is an illustrative compliant graphic that can be used to indicate that the activity corresponding to the quality metric in the current time period has been charted as being complete or is otherwise compliant. In one embodiment, for a reoccurring quality metric, the compliant graphic may also indicate that the quality metric is compliant, for example, for the most-recent past time period.

FIGS. 3G, 3H, 3I, 3J, and 3K are graphics that visibly provide the status of multiple time periods. For example, the graphic shown in FIG. 3G is an illustrative actionable/noncompliant graphic that may be used to indicate that the quality metric (a) is actionable for the current time period and (b) was noncompliant in the most-recent past time period (or multiple time periods). Similarly, the graphic shown in FIG. 3H is an illustrative urgent/noncompliant graphic that may be used to indicate that the quality metric (a) is urgent for the current time period and (b) was noncompliant in the most-recent past time period (or multiple time periods). The graphic shown in FIG. 3I is an illustrative contraindicated/noncompliant graphic that may be used to indicate that the quality metric (a) is contraindicated for the current time period and (b) was noncompliant in the most-recent past time period (or multiple time periods) and. The graphic shown in FIG. 3J is an illustrative compliant/noncompliant graphic that may be used to indicate that the quality metric (a) is compliant for the current time period and (b) was noncompliant in the most-recent past time period (or multiple time periods). The graphic shown in FIG. 3K is an illustrative non-applicable/noncompliant graphic that may be used to indicate that the quality metric (a) is non-applicable for the current time period and (b) was noncompliant in the most-recent past time period (or multiple time periods).

According to one embodiment, a color may be assigned to one or more of the above-referenced graphics to further distinguish them from one another. For example, the actionable graphic of FIG. 3A may be yellow, while the urgent graphic of FIG. 3B may be red, and the compliant graphic of FIG. 3F may be green. As will be recognized, other color schemes may likewise be applied to any or all of the graphics associated with the quality metrics without departing from the spirit or scope of embodiments described herein. Similarly, various symbols, numbers, and letters may be used as part of the graphics as well.

FIGS. 4-6 show illustrative graphic progressions corresponding to statuses that may be associated with a given quality metric. For example, FIG. 4 provides illustrative graphic progressions that may correspond to statuses of a non-reoccurring quality metric. In this example, the quality metric's status and corresponding graphic being displayed/presented may be changed from actionable to urgent if the particular activity for the quality metric has not been charted as having been completed and the time is approaching expiration of the predetermined time period for completion. Similarly, the quality metric's status and corresponding graphic being displayed/presented may be changed from urgent to noncompliant if the time period for the activity for the quality metric has expired without charting the corresponding activity as being completed.

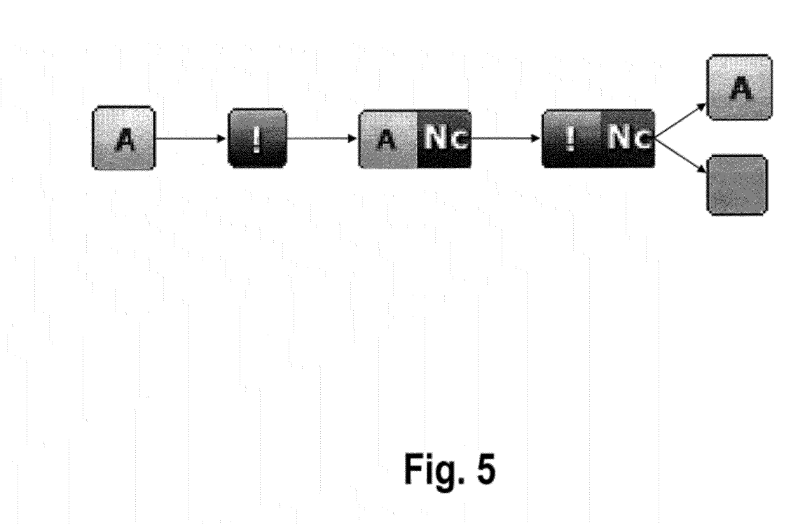

FIG. 5 provides illustrative graphic progressions that may correspond to statuses of a reoccurring quality metric. In this example, the quality metric's status and corresponding graphic being displayed/presented may be changed from actionable to urgent if the particular activity for the quality metric has not been charted as having been completed and the time is approaching expiration of the predetermined time period for completion. Similarly, the quality metric's status and corresponding graphic being displayed/presented may be changed from urgent to actionable/noncompliant (or compliant/noncompliant). As previously described, the actionable/noncompliant state may be used to indicate that the quality metric (a) was noncompliant in the most-recent past time period (or multiple time periods) and (b) is actionable for the current time period. In this example, if the particular activity has been performed/completed but not documented as having been performed/completed within the most-recent past time period, the real-time display of the actionable/noncompliant graphic allows for correction to occur while the patient is still being treated within the health care facility.

Continuing with the above example, the quality metric's status and corresponding graphic being displayed/presented may be changed from actionable/noncompliant to urgent/noncompliant. This state may be used to indicate that the quality metric (a) was noncompliant in the most-recent past time period (or multiple time periods) and (b) is urgent for the current time period. In response to receiving some form of input indicating that the activity corresponding to the quality metric has been performed (e.g., receiving input charting the activity) for both most-recent past time period and the current time period, the quality metric's status and corresponding graphic being displayed/presented may be changed from urgent/noncompliant to actionable or compliant (depending on the circumstances). As discussed, in various embodiments, this functionality may provide a user with the opportunity to correct documentation when a quality metric (e.g., activity) has been performed/completed and not documented, for example. Thus, for instance, if a medical provider actually performed/completed a quality metric (e.g., activity) within a past time period (e.g., the most-recent past time period), the medical provider may view the dashboard and be reminded to chart or record the performance/completion of the quality metric (e.g., activity) within the corresponding time period. In various embodiments, this may allow a medical provider (e.g. nurse) to ensure the complete documentation of evidence-based care associated with various quality metrics or sets of quality metrics. As will be recognized, the charting or recording of the performance/completion of a quality metric may occur (a) before a predetermined time period for the quality metric begins, (b) during a predetermined time period for the quality metric, and/or (c) after a predetermined time period for the quality metric ends.

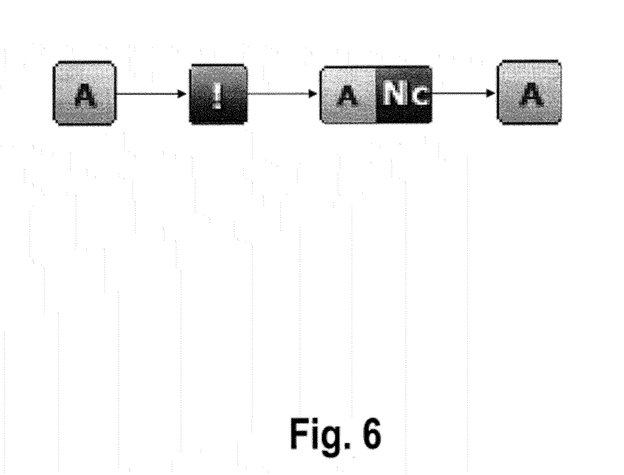

FIG. 6 shows a permutation in which some form of input has been received indicating that the activity corresponding to the noncompliant quality metric for the most-recent past time period has been performed, causing the noncompliant graphic to disappear. In this example, the quality metric for the current time period remains actionable as no input was received indicating that the quality metric was performed/completed. In this example, the medical provider charted or recorded the completion/performance of the quality metric after the predetermined time period for completing/performing the quality metric ended. In other words, the medical provider back-charted the care provided.

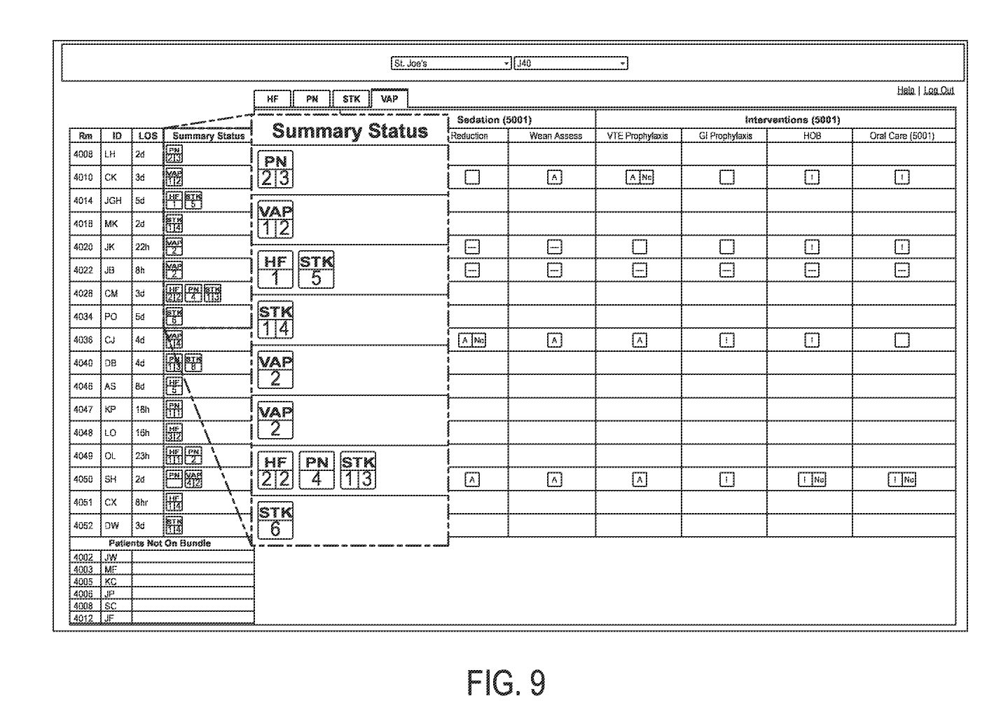

As will be recognized, a variety of approaches and techniques may be used to display/present the various statuses of quality metrics. For example, as shown in FIG. 9, summary graphics may be displayed/presented that provide an indication of an entire set of quality metrics or sets of quality metrics. In one embodiment, the summary graphics may be used to provide an indication of all or some quality metrics associated with a set of quality metrics. As shown in FIG. 9, the circled summary graphic for the PN set of quality metrics indicates that two of its quality metrics are urgent, three of its quality metrics are actionable, and no quality metrics from past time periods are noncompliant. Similarly, the circled summary graphic for the STK set of quality metrics indicates that six of its quality metrics are actionable and at least one quality metric from a past time period is noncompliant.

The following example is for a reoccurring quality metric for patient John Doe. In this example, the quality metric being monitored may require elevating the head of John Doe's bed 30 to 45 degrees at least once every twelve hours. Thus, in this example, once the quality metric (or set of quality metrics) has been initiated for monitoring for John Doe, monitoring of the quality metric may begin. As discussed, this may involve the monitoring server 100 (a) extracting clinical patient data on a routine, periodic, and/or continuous basis to determine whether the quality metric has been performed/completed within predetermined time periods and (b) updating the status of the quality metric accordingly. For instance, depending on the external and/or internal standards associated with the quality metric, the monitoring server 100 may be configured to indicate the status of the quality metric (and cause display of the corresponding graphic) as compliant during the first eight hours of a first 12-hour time period (at this point referred to as the current time period). In one embodiment, the monitoring server 100 may be configured to indicate the status of the quality metric (and cause display of the corresponding graphic) as actionable between hours eight and 11 of the first 12-hour time period if charting is not received indicating that the quality metric has been performed/completed within the first 12-hour time period. Similarly, the monitoring server 100 may be configured to indicate the status of the quality metric (and cause display of the corresponding graphic) as urgent from hour 11 until just before the end of the first 12-hour time period if charting is not received indicating that the quality metric has been performed/completed within the first 12-hour time period. If charting is not received indicating that the quality metric has been performed/completed within the first 12-hour time period, the monitoring server 100 may be configured to indicate the status of the quality metric (and cause display of the corresponding graphic) as noncompliant for that time period. It should be noted that after the first 12-hour time period expires, the first 12-hour time period is no longer the current time period; rather, it becomes the most-recent past time period. Similarly, a second 12-hour time period becomes the current time period.

Continuing with the above example, in one embodiment, the monitoring server 100 may be configured to indicate the status of the quality metric (and cause display of the corresponding graphic) as compliant/noncompliant during the first eight hours of the second 12-hour time period (at this point referred to as the current time period) if charting is not received indicating that the quality metric has been performed/completed within either the first or second 12-hour time periods. Similarly, the monitoring server 100 may be configured to indicate the status of the quality metric (and cause display of the corresponding graphic) as actionable/noncompliant between hours eight and 11 of the second 12-hour time period if charting is not received indicating that the quality metric has been performed/completed within either the first or second 12-hour time periods. In one embodiment, the monitoring server 100 may be configured to indicate the status of the quality metric (and cause display of the corresponding graphic) as urgent/noncompliant from hour 11 until just before the end of the second 12-hour time period if charting is not received indicating that the quality metric has been performed/completed within either the first or second 12-hour time periods. In one embodiment, this process may continue to repeat as long as John Doe remains in the health care facility. For example, the monitoring server 100 may be configured to continue monitoring and updating 12-hour time periods for the entire length of John Doe's stay in the health care facility (e.g., third, fourth, and fifth time periods).

In one embodiment, as discussed, the monitoring server 100 may extract clinical patient data and update the status of the current time period and/or the one or more past time periods routinely, periodically, and/or continuously to reflect the actual status of the respective time periods. Moreover, the monitoring server 100 may update the status of the current time period and/or the one or more past time periods in response to the charting of an event or the recordation of the performance/completion of a quality metric (e.g., activity). Thus, at any time, a medical provider may update the status of the current time period and/or one or more past time periods (including the most-recent past time period) to reflect the actual care provided. Such documentation may occur (a) before a predetermined time period for the quality metric begins, (b) during a predetermined time period for the quality metric, and/or (c) after a predetermined time period for the quality metric ends. Thus, in some embodiments, the monitoring server 100 may update the status of a quality metric as compliant for a time period after the time for performing/completing the quality metric has ended. Accordingly, when the noncompliant status was due to a charting error or failure to record a quality metric (e.g., activity) that was actually performed/completed within a predetermined time period, the prior status of noncompliance may be removed in response to receipt of the indication of the performance/completion of the quality metric (e.g., activity) and the corresponding graphic may be displayed/presented accordingly. As will be recognized, a variety of approaches and techniques may be used to update the quality metrics and/or clinical patient data. Accordingly, the foregoing examples are provided for illustrative purposes only and should not be taken in any way as limiting embodiments of the present invention to the examples provided.

In various embodiments, this approach may allow medical providers with the ability to quickly and efficiently identify quality metrics (e.g., activities) that need to be performed/completed for a patient, a medical provider, a department, a health care unit, a floor, and/or a health care facility. In certain embodiments, such concepts may further provide medical providers with the ability to (a) identify trends of noncompliance with quality metrics, (b) prevent noncompliance with quality metrics before they occur, and/or (c) identify opportunities to correct documentation when a quality metric has been performed but not documented while the patient is still in the health care facility.

### IV. Conclusion

In some embodiments of the present invention, such concepts may enable medical providers to relatively easily view the quality metrics (e.g., activities) that should be performed/completed to ensure compliance with external and local standards for patient care corresponding to the various conditions, illnesses, diagnoses, and/or treatments. And as will be recognized, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for monitoring quality metrics, the method comprising:
receiving input initiating the monitoring of a quality metric associated with a patient in a health care facility, wherein the quality metric is associated with one or more activities that are to be performed corresponding to the patient;
identifying clinical patient data corresponding to the quality metric;
determining, based at least in part on the clinical patient data, whether an activity associated with the quality metric has been performed within (a) a first predetermined time period and (b) a second predetermined time period;
after determining whether the activity associated with the quality metric has been performed within the first predetermined time period and the second predetermined time period, updating a status of the quality metric to indicate whether the activity associated with the quality metric has been performed within the first predetermined time period and the second predetermined time period; and
after updating the status of the quality metric, causing display of a first graphic for the quality metric indicating the status of the first predetermined time period and the second predetermined time period.

2. The method of claim 1, wherein the first predetermined time is a past time period and the second predetermined time period is a current time period.

3. The method of claim 1, wherein the quality metric corresponds to external standards of care for a health care condition.

4. The method of claim 1, wherein the input initiating the monitoring of the quality metric is received from a user entering an order set.

5. The method of claim 1 further comprising:
identifying clinical patient data corresponding to the quality metric;
determining, based at least in part on the clinical patient data, whether the activity associated with the quality metric has been performed within (a) the second predetermined time period and (b) a third predetermined time period;
after determining whether the activity associated with the quality metric has been performed within the second predetermined time period and the third predetermined time period, updating the status of the quality metric to indicate whether the activity associated with the quality metric has been performed within the second predetermined time period and the third predetermined time period; and
after updating the status of the quality metric, causing display of a second graphic for the quality metric indicating the status of the second predetermined time period and the third predetermined time period.

6. The method of claim 5 further comprising:
receiving input indicating that the activity associated with the quality metric has been performed within at least one of the second predetermined time period or the third predetermined time period; and
after receiving the input indicating that the activity associated with the quality metric has been performed, updating the status of the quality metric and causing display of a third graphic for the quality metric indicating the status of the second predetermined time period and the third predetermined time period.

7. The method of claim 1 further comprising:
monitoring a set of quality metrics associated with the quality metric;
identifying the status of each quality metric of the set of quality metrics; and
causing display of a second graphic indicating the status of each quality metric of the set of quality metrics.

8. A computer program product for monitoring quality metrics, the computer program product comprising at least one computer-readable storage medium having computer-readable program code portions stored therein, the computer-readable program code portions comprising:
an executable portion configured to receive input initiating the monitoring of a quality metric associated with a patient in a health care facility, wherein the quality metric is associated with one or more activities that are to be performed corresponding to the patient;
an executable portion configured to identify clinical patient data corresponding to the quality metric;
an executable portion configured to determine, based at least in part on the clinical patient data, whether an activity associated with the quality metric has been performed within (a) a first predetermined time period and (b) a second predetermined time period;
an executable portion configured to, after determining whether the activity associated with the quality metric has been performed within the first predetermined time period and the second predetermined time period, update a status of the quality metric to indicate whether the activity associated with the quality metric has been performed within the first predetermined time period and the second predetermined time period; and
an executable portion configured to, after updating the status of the quality metric, cause display of a first graphic for the quality metric indicating the status of the first predetermined time period and the second predetermined time period.

9. The computer program product of claim 8, wherein the first predetermined time is a past time period and the second predetermined time period is a current time period.

10. The computer program product of claim 8, wherein the quality metric corresponds to external standards of care for a health care condition.

11. The computer program product of claim 8, wherein the input initiating the monitoring of the quality metric is received from a user entering an order set.

12. The computer program product of claim 8 further comprising:
an executable portion configured to identify clinical patient data corresponding to the quality metric;
an executable portion configured to determine, based at least in part on the clinical patient data, whether the activity associated with the quality metric has been performed within (a) the second predetermined time period and (b) a third predetermined time period;
an executable portion configured to, after determining whether the activity associated with the quality metric has been performed within the second predetermined time period and the third predetermined time period, update the status of the quality metric to indicate whether the activity associated with the quality metric has been performed within the second predetermined time period and the third predetermined time period; and
an executable portion configured to, after updating the status of the quality metric, cause display of a second graphic for the quality metric indicating the status of the second predetermined time period and the third predetermined time period.

13. The computer program product of claim 12 further comprising:
an executable portion configured to receive input indicating that the activity associated with the quality metric has been performed within at least one of the second predetermined time period or the third predetermined time period; and
an executable portion configured to, after receiving the input indicating that the activity associated with the quality metric has been performed, update the status of the quality metric and cause display of a third graphic for the quality metric indicating the status of the second predetermined time period and the third predetermined time period.

14. The computer program product of claim 8 further comprising:
an executable portion configured to monitor a set of quality metrics associated with the quality metric;
an executable portion configured to identify the status of each quality metric of the set of quality metrics; and
an executable portion configured to cause display of a second graphic indicating the status of each quality metric of the set of quality metrics.

15. An apparatus comprising at least one processor and at least one memory including computer program code, the at least one memory and the computer program code configured to, with the processor, cause the apparatus to at least:
receive input initiating the monitoring of a quality metric associated with a patient in a health care facility, wherein the quality metric is associated with one or more activities that are to be performed corresponding to the patient;
identify clinical patient data corresponding to the quality metric;
determine, based at least in part on the clinical patient data, whether an activity associated with the quality metric has been performed within (a) a first predetermined time period and (b) a second predetermined time period;
after determining whether the activity associated with the quality metric has been performed within the first predetermined time period and the second predetermined time period, update a status of the quality metric to indicate whether the activity associated with the quality metric has been performed within the first predetermined time period and the second predetermined time period; and
after updating the status of the quality metric, cause display of a first graphic for the quality metric indicating the status of the first predetermined time period and the second predetermined time period.

16. The apparatus of claim 15, wherein the first predetermined time is a past time period and the second predetermined time period is a current time period.

17. The apparatus of claim 15, wherein the quality metric corresponds to external standards of care for a health care condition.

18. The apparatus of claim 15, wherein the input initiating the monitoring of the quality metric is received from a user entering an order set.

19. The apparatus of claim 15, wherein the memory and computer program code are further configured to, with the processor, cause the apparatus to:
identify clinical patient data corresponding to the quality metric;
determine, based at least in part on the clinical patient data, whether the activity associated with the quality metric has been performed within (a) the second predetermined time period and (b) a third predetermined time period;
after determining whether the activity associated with the quality metric has been performed within the second predetermined time period and the third predetermined time period, update the status of the quality metric to indicate whether the activity associated with the quality metric has been performed within the second predetermined time period and the third predetermined time period; and
after updating the status of the quality metric, cause display of a second graphic for the quality metric indicating the status of the second predetermined time period and the third predetermined time period.

20. The apparatus of claim 19, wherein the memory and computer program code are further configured to, with the processor, cause the apparatus to:
receive input indicating that the activity associated with the quality metric has been performed within at least one of the second predetermined time period or the third predetermined time period; and
after receiving the input indicating that the activity associated with the quality metric has been performed, update the status of the quality metric and cause display of a third graphic for the quality metric indicating the status of the second predetermined time period and the third predetermined time period.

21. The apparatus of claim 15, wherein the memory and computer program code are further configured to, with the processor, cause the apparatus to:
monitor a set of quality metrics associated with the quality metric;
identify the status of each quality metric of the set of quality metrics; and
cause display of a second graphic indicating the status of each quality metric of the set of quality metrics.
